(19) United States
(12) Patent Application Publication
(10) Pub. No.: US 2025/0096365 A1
(43) Pub. Date: Mar. 20, 2025

(54) BATTERY PACK FOR A VEHICLE

(71) Applicants: HYUNDAI MOTOR COMPANY, Seoul (KR); KIA CORPORATION, Seoul (KR)

(72) Inventors: Hyun Chang Kang, Seoul (KR); Jeong Hun Seo, Suwon-si (KR); Ji Woong Jung, Anyang-si (KR); Yoon Hyuk Kang, Seoul (KR); Jun Ho Suh, Gwacheon-si (KR); Yong Hwan Choi, Seoul (KR); Jun Young Kang, Hwaseong-si (KR)

(73) Assignees: HYUNDAI MOTOR COMPANY, Seoul (KR); KIA CORPORATION, Seoul (KR)

(21) Appl. No.: 18/609,771

(22) Filed: Mar. 19, 2024

(30) Foreign Application Priority Data
Sep. 20, 2023 (KR) 10-2023-0125781

(51) Int. Cl. H01M 10/658; H01M 10/625; H01M 50/209

(52) U.S. Cl. CPC H01M 10/658; H01M 10/625; H01M 50/209; H01M 2220/20

(57) ABSTRACT

A battery pack for a vehicle may include: a plurality of battery modules arranged on a plane; a lower case forming an accommodation space surrounding the lower and lateral portions of the plurality of battery modules; a pack cover coupled to the upper portion of the lower case so as to cover the upper portion of the accommodation space; a plurality of inner members provided in the accommodation space to separate the plurality of battery modules; and a heat blocker provided between the pack cover and the inner members so as to thermally isolate the battery modules separated by the inner members.

### CROSS-REFERENCE TO RELATED APPLICATIONS

This application claims the benefit of and priority to Korean Patent Application No. 10-2023-0125781, filed on Sep. 20, 2023, the disclosure of which is herein incorporated by reference in its entirety.

### BACKGROUND

### 1. Field

The present disclosure relates to a structure of a battery pack mounted to a vehicle.

### 2. Description of the Prior Art

An electric vehicle or hybrid vehicle is equipped with a battery to supply power to a drive motor that exerts the driving force of the vehicle. The battery is usually mounted to the vehicle body in the form of a battery pack that accommodates multiple battery modules, and each battery module is configured as a plurality of battery cells.

The battery cell may ignite for various reasons, and in this case, flames may spread to adjacent battery cells, resulting in thermal runaway.

Furthermore, as described above, a fire occurring in one battery module may spread to other adjacent battery modules, causing overall thermal runaway of the battery pack.

The foregoing described as the background art is intended merely to aid in the understanding of the background of the present disclosure. Therefore, the foregoing is not intended to mean that the present disclosure falls within the purview of the related art already known to those having ordinary skill in the art.

### SUMMARY

The present disclosure has been made in order to solve the above-mentioned problems in the prior art. An aspect of the present disclosure is to provide a battery pack for a vehicle, which may structurally block, when ignition occurs within the battery pack, the spread of flames to other adjacent battery modules. As a result, the configuration effectively delays heat transfer between the battery modules and thermal runaway of the battery pack.

According to an embodiment of the present disclosure, a battery pack for a vehicle may include: a plurality of battery modules arranged on a plane; and a lower case forming an accommodation space surrounding lower and lateral portions of the plurality of battery modules. The battery pack may also include: a pack cover coupled to an upper portion of the lower case so as to cover the upper portion of the accommodation space; and a plurality of inner members provided in the accommodation space to separate the plurality of battery modules. Additionally, the battery pack includes a heat blocker provided between the pack cover and the plurality of inner members so as to thermally isolate the plurality of battery modules separated by the plurality of inner members.

The lower case may include a front wall, a rear wall, and a pair of side walls connecting both ends of the front wall and rear wall in the forward and backward directions. The plurality of inner members may include a longitudinal member installed to extend in the forward and backward directions of the lower case and a transverse member installed to extend in the transverse direction of the lower case to intersect with the longitudinal member.

At least one of the front wall, rear wall, and the pair of side walls of the lower case may have a venting mechanism for discharging gas generated from the plurality of battery modules to an outside.

The heat blocker may be provided to extend along a lengthwise direction of an inner member of the plurality of inner members and above the inner member.

The heat blocker may be configured as a channel portion of the pack cover, which is formed by bending a portion of the pack cover down toward the inner member.

The heat blocker may be configured as a blocking bracket that includes a plurality of partition walls protruding from the pack cover toward the inner member and formed to extend along the lengthwise direction of the inner member and is coupled to the lower surface of the pack cover.

The blocking bracket may be formed to have a cross-section in a trapezoidal shape, and both ends of the trapezoidal cross-section may be coupled to the lower surface of the pack cover.

The heat blocker may be configured as a blocking panel that includes a single partition wall protruding from the pack cover toward the inner member and formed to extend along the lengthwise direction of the inner member and is coupled to a lower surface of the pack cover.

The heat blocker may be configured as a flame arrestor element installed between the pack cover and the inner member. An element guide supporting the flame arrestor element may be provided in at least one of a lower portion of the pack cover and an upper portion of the inner member.

The height of the inner member above which the heat blocker is not provided, among the plurality of inner members, may be equal to or less than a height of a module outlet of a battery module of the plurality of battery modules.

The heat blocker may be configured as a heat-resistant pad installed between the pack cover and the inner member. The heat-resistant pad may be attached to at least one side of the pack cover and the inner member.

A module outlet of a battery module of the plurality of battery modules may be disposed toward the heat blocker. The heat blocker may be divided in corresponding portions between adjacent module outlets.

A battery module of the plurality of battery modules may include a module cover that covers upper sides of overlapping battery cells and forms a module outlet that is open toward the heat blocker.

In addition, a battery pack for a vehicle according to another aspect of the present disclosure may include: a front wall, a rear wall, and a pair of side walls forming an accommodation space for accommodating a plurality of battery modules. The battery pack may include: a longitudinal member provided to extend between the front wall and the rear wall so as to partition the accommodation space; and a transverse member provided to extend between the pair of side walls so as to partition the accommodation space. The battery pack may include: a pack cover coupled to upper portions of the front wall, rear wall, and pair of side walls so as to cover the accommodation space; and a plurality of battery modules disposed in the accommodation space partitioned by the longitudinal member and transverse member. A battery module of the plurality of battery modules may include a module cover that covers upper portions of overlapping battery cells and has a module outlet leading to the accommodation space. The pack cover has a pack protrusion that protrudes down toward the accommodation space.

The module outlet formed on the module cover of the battery module may be disposed to face the pack protrusion of the pack cover.

The pack protrusion of the pack cover may be formed in at least one of a shape extending toward the front wall and rear wall and a shape extending toward the pair of side walls.

The pack protrusion of the pack cover may extend above the longitudinal member or transverse member along a lengthwise direction of the longitudinal member or transverse member so that gas movement on both sides of the pack protrusion is restricted to each other.

The battery module may include: a plurality of battery cells overlapping each other between two end plates on both sides; and sensing blocks provided on the front and rear sides of the two end plates and configured to make an electrical connection between the battery cells and sense voltage. The battery module may also include a module cover coupled to the two end plates or sensing blocks to cover the upper portions of the overlapping battery cells, such as to restrict heat transfer to an outside of the battery module. The battery module also includes a fireproof panel provided between the battery cells and extending toward the lower surface of the module cover to delay heat transfer between the battery cells.

The fireproof panel may form a plane perpendicular to the module outlet of the module cover and may be provided between the battery cells.

The fireproof panel may have a connection groove formed on the upper portion thereof to be locally spaced apart from the lower surface of the module cover.

The present disclosure may structurally block, when ignition occurs within a battery pack, the spread of flames to other adjacent battery modules. As a result, the configuration effectively delays heat transfer between the battery modules and thermal runaway of the battery pack.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 is a diagram illustrating a battery pack for a vehicle according to an embodiment of the present disclosure;

FIG. 2 is a diagram illustrating a structure of the battery pack in FIG. 1 in more detail;

FIG. 3 is a diagram illustrating a structure of a battery module accommodated in the battery pack in FIG. 1;

FIG. 4 is a diagram illustrating a first battery module in an embodiment of the present disclosure;

FIG. 5 is a cross-sectional view taken along line F5-F5 in FIG. 4;

FIG. 6 is a cross-sectional view taken along line F6-F6 in FIG. 4;

FIG. 7 is a diagram illustrating a second battery module in an embodiment of the present disclosure;

FIG. 8 is a cross-sectional view taken along line F8-F8 in FIG. 7;

FIG. 9 is a cross-sectional view taken along line F9-F9 in FIG. 7;

FIG. 10 is a diagram illustrating a battery pack in which a first battery module is accommodated, in an embodiment of the present disclosure;

FIG. 11 is a cross-sectional view taken along line F11-F11 in FIG. 10;

FIG. 12 is a diagram illustrating a battery pack in which a second battery module is accommodated, in an embodiment of the present disclosure;

FIG. 13 is a cross-sectional view taken along line F13-F13 in FIG. 12;

FIG. 14 is a diagram illustrating a first embodiment of a heat blocker in an embodiment of the present disclosure;

FIG. 15 is a diagram illustrating an overturned state of the pack cover in FIG. 14;

FIG. 16 is a diagram illustrating a second embodiment of a heat blocker in an embodiment of the present disclosure;

FIG. 17 is a diagram illustrating an overturned state of the pack cover in FIG. 16;

FIG. 18 is a diagram illustrating a third embodiment of a heat blocker in an embodiment of the present disclosure;

FIG. 19 is a diagram illustrating an overturned state of the pack cover in FIG. 18;

FIG. 20 is a diagram illustrating a fourth embodiment of a heat blocker in an embodiment of the present disclosure;

FIG. 21 is a diagram illustrating a fifth embodiment of a heat blocker in an embodiment of the present disclosure; and

FIGS. 22 and 23 are diagrams respectively illustrating an embodiment in which a heat blocker is divided, in an embodiment of the present disclosure.

### DETAILED DESCRIPTION

Hereinafter, embodiments disclosed in the present specification are described in detail with reference to the accompanying drawings, and the same or similar elements are given the same and similar reference numerals, so duplicate descriptions thereof have been omitted.

The terms “module” and “unit” used for the elements in the following description are given or interchangeably used in consideration of only the ease of writing the specification, and do not have distinct meanings or roles by themselves.

In describing the embodiments disclosed in the present specification, when the detailed description of the relevant known technology is determined to unnecessarily obscure the gist of the present disclosure, the detailed description is omitted. Furthermore, the accompanying drawings are for illustration purposes only and are not intended to limit the scope of the present disclosure in any way. Additionally, it should be understood that all changes, equivalents, or substitutes thereof are included in the spirit and scope of the present disclosure.

Terms including an ordinal number such as “first,” “second,” or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expressions “include” or “have” are intended to specify the existence of mentioned features, numbers, steps, operations, elements, components, or combinations thereof. The expressions should be construed as not precluding the possible existence or addition of one or more other features, numbers, steps, operations, elements, components, or combinations thereof.

When a component, device, element, or the like of the present disclosure is described as having a purpose or performing an operation, function, or the like, the component, device, or element should be considered herein as being “configured to” meet that purpose or perform that operation or function.

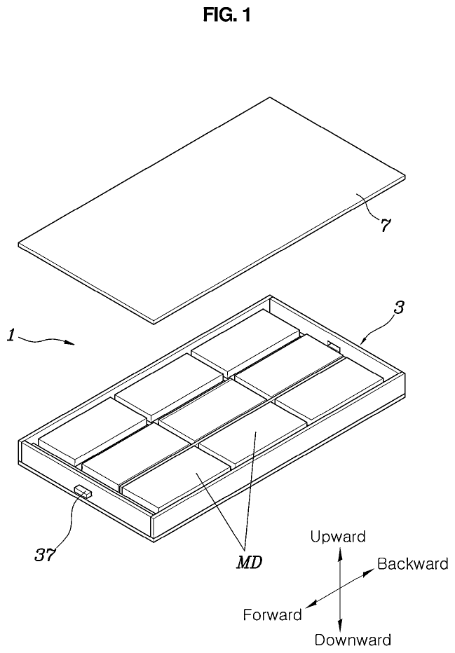

FIG. 1 is a diagram illustrating a battery pack 1 for a vehicle according to the present disclosure. A lower case 3 accommodates multiple battery modules MD therein, and an upper pack cover 7 is coupled thereto, thereby producing an accommodation space that accommodates and protects the internal battery modules MD together with the lower case 3.

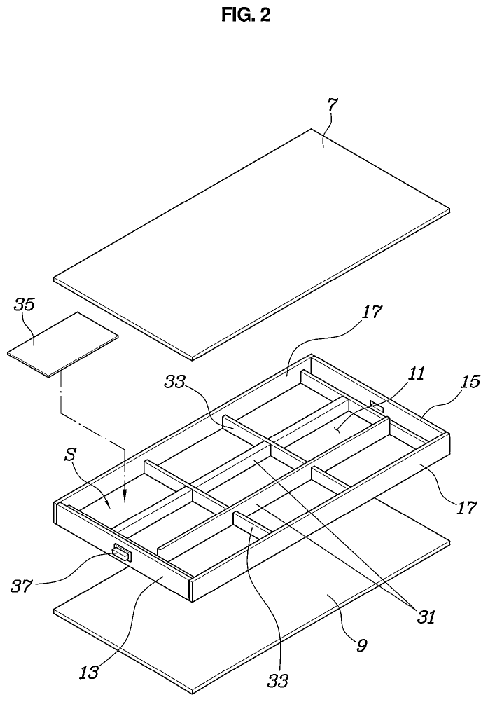

FIG. 2 is a diagram illustrating the structure of the battery pack 1 in FIG. 1 in more detail. A front wall 13, a rear wall 15, and side walls 17 are combined on a lower plate 9 and a metal plate 11 to form an accommodation space S to accommodate the battery modules MD. A plurality of inner members 19 are arranged to separate the accommodated battery modules MD.

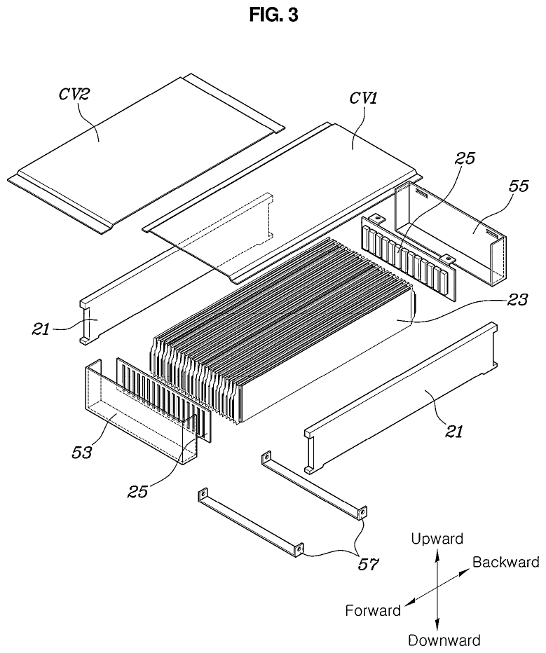

FIG. 3 is an exploded view illustrating the structure of a battery module MD accommodated in the battery pack 1 in FIG. 1. Multiple battery cells 23 are arranged between two end plates 21 so as to overlap each other. A sensing block 25 is provided at the front and rear of the battery module MD in order to make an electrical connection between the battery cells 23 and to measure voltage or the like.

For reference, in the present disclosure, the battery module MD includes two types of battery modules, i.e., a first battery module MD1 and a second battery module MD2, which are distinguished by the module cover CV at the top thereof.

In FIG. 3, although one battery module MD is shown in an exploded view, the module cover CV is illustrated as both the first module cover CV1 and the second module cover CV2 for comparison.

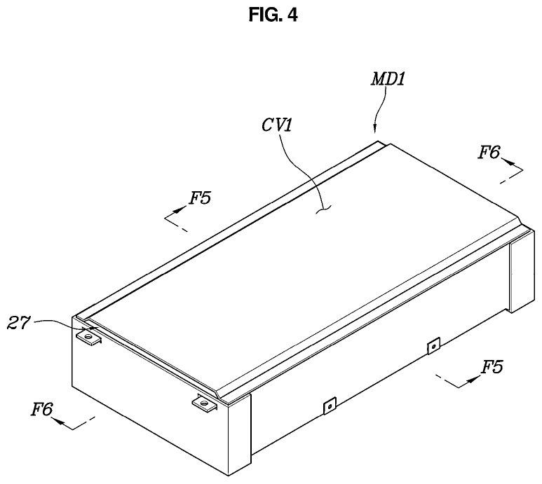

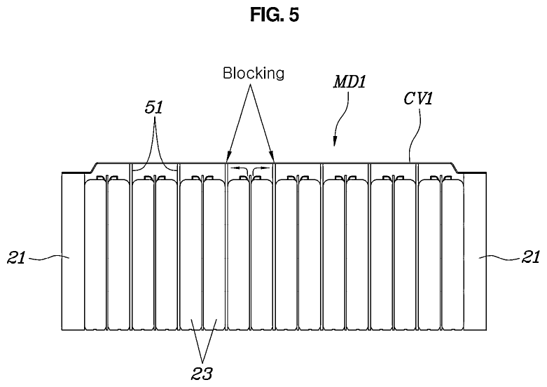

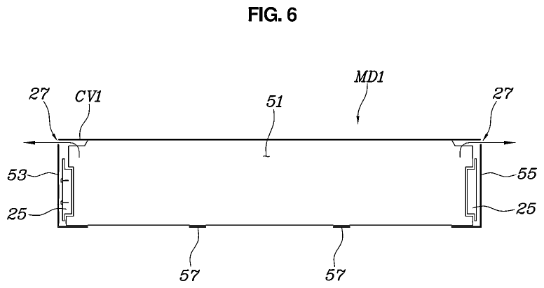

In other words, the first battery module MD1 is provided with the first module cover CV1, as shown in FIGS. 4 to 6, so that both ends of the module cover CV are coupled to the two end plates 21. Additionally, a module outlet 27 is formed between the module cover CV and the sensing block 25 at the front and rear thereof.

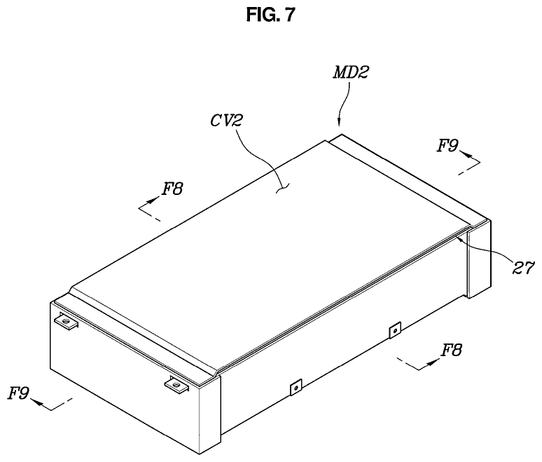

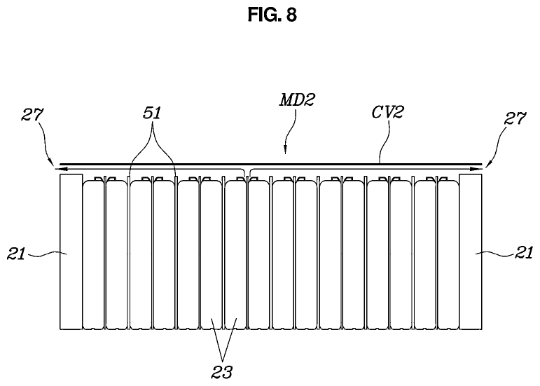

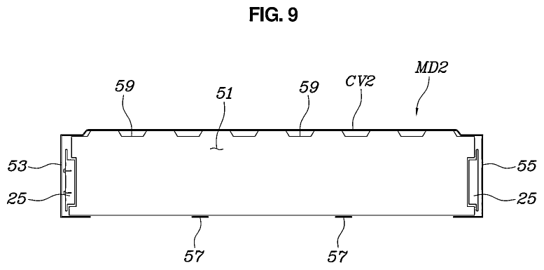

In addition, the second battery module MD2 is provided with the second module cover CV2, as shown in FIGS. 7 to 9, so that the front and rear ends of the module cover CV are coupled to the sensing block 25. Additionally, a module outlet 27 is formed between the module cover CV and the end plate 21 on both sides thereof.

Referring to FIGS. 1 to 21, the battery pack 1 for a vehicle according to the present disclosure is configured to include a plurality of battery modules MD arranged on a plane, and a lower case 3 forming an accommodation space S surrounding the lower and lateral sides of the plurality of battery modules MD. The battery pack also includes a pack cover 7 coupled to the top of the lower case 3 so as to cover the upper portion of the accommodation space S, and a plurality of inner members 19 provided in the accommodation space S so as to separate the plurality of battery modules MD. Additionally, the battery pack 1 includes a heat blocker 29 provided between the pack cover 7 and the plurality of inner members 19 so as to thermally isolate the battery modules MD separated by the inner members 19.

In other words, the battery pack 1 of the present disclosure is configured such that a plurality of battery modules MD is accommodated in the accommodation space S formed by the lower case 3 and the pack cover 7. A plurality of inner members 19 is provided to secure the rigidity of the battery pack 1 while separating the battery modules MD accommodated in the accommodation space S and supporting the same. The heat blocker 29 is provided between the pack cover 7 and the inner members 19 to effectively suppress, if ignition occurs in any one battery module MD, the spread of fire to other adjacent battery modules MD.

The lower case 3 is configured to include a front wall 13, a rear wall 15, and both side walls 17 connecting both ends of the front wall 13 and the rear wall 15 in the forward and backward directions. The inner members 19 include longitudinal members 31 installed extending in the forward and backward directions (i.e., a lengthwise or longitudinal direction) of the lower case 3 and transverse members 33 installed in the transverse direction (i.e., a widthwise or lateral direction) of the lower case 3, which intersect each other.

The lower case 3 may be coupled to the lower portions of the front wall 13, rear wall 15, and both side walls 17 so as to support the lower portions of the battery modules MD. A metal plate 11, which does not melt in the event of a fire in the battery modules MD, may be also provided. Additionally, a lower plate 9 may be coupled to the lower portion of the metal plate 11 to overlap the same.

In addition, a thermal interface material (TIM) pad 35 may be provided on the metal plate 11 of the lower case 3 to facilitate heat transfer between the battery modules MD and the metal plate 11.

In addition, although not shown, a cooling channel through which refrigerant for cooling the battery modules MD may flow may be configured below the metal plate 11.

A venting mechanism 37 capable of discharging gas generated from the accommodated battery modules MD to the outside may be provided on at least one of the front wall 13, rear wall 15, and both side walls 17 of the lower case 3.

For reference, FIGS. 1 and 2 illustrate that a venting mechanism 37 is provided on the front wall 13 and the rear wall 15. Each venting mechanism 37 may be configured as a valve device that prevents moisture or foreign substances from flowing into the battery pack 1 under normal circumstances. Furthermore, if a fire occurs in the internal battery modules MD, each venting mechanism 37 is configured to discharge gas emitted from the battery cells 23 to the outside. The heat blocker 29 is provided in the upper portions of the inner members 19 so as to be extending along the longitudinal direction of the inner members 19.

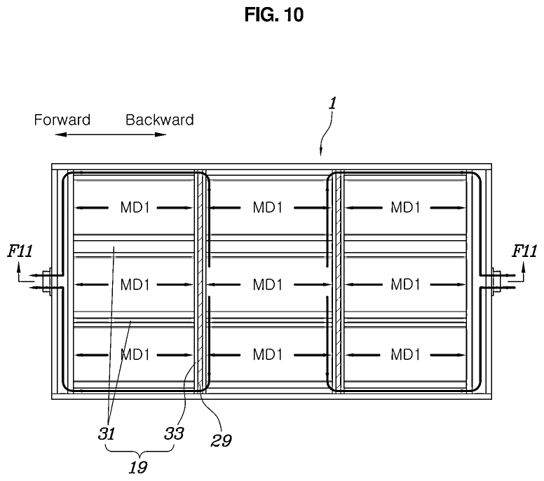

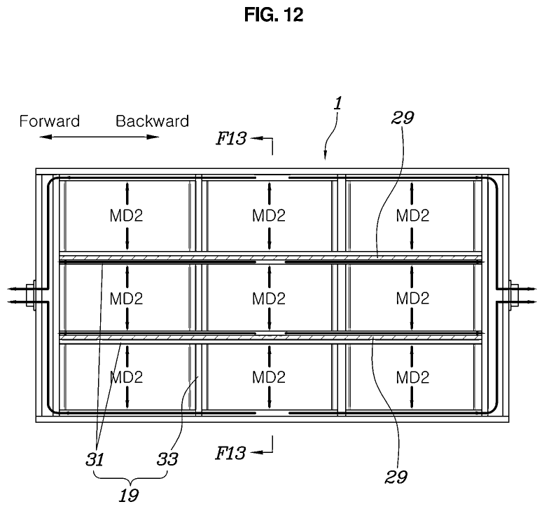

The battery pack 1 of an embodiment of the present disclosure, for example, may be configured to accommodate only the first battery modules MD1 as shown in FIG. 10 or may be configured to accommodate only the second battery modules MD2 as shown in FIG. 12.

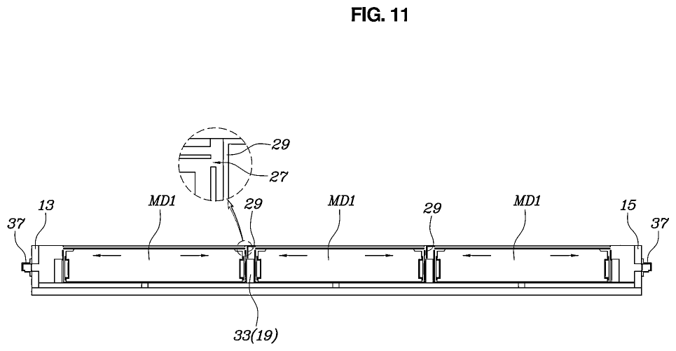

In the embodiment in FIGS. 10 and 11, since the module outlet 27 of the first battery module MD1 is open in the forward and backward directions, the heat blocker 29 is provided only above the transverse members 33 of the inner members 19 and is not provided above the longitudinal members 31.

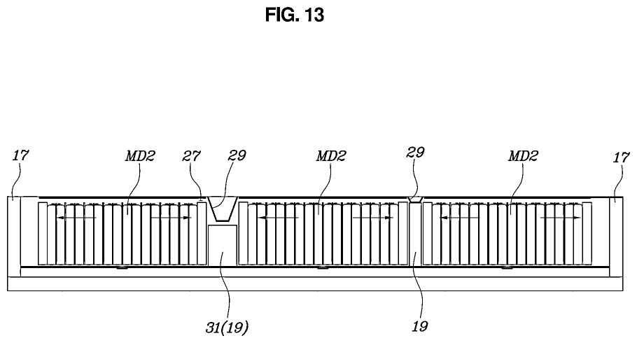

In the embodiment in FIGS. 12 and 13, since the module outlet 27 of the second battery module MD2 is open in the transverse direction, the heat blocker 29 is provided only above the longitudinal members 31 of the inner members 19 and is not provided above the transverse members 33.

In other words, the heat blocker 29 is selectively provided only at positions capable of blocking gas discharged from the module outlet 27 of respective battery modules MD.

The height of the inner members 19 above which the heat blocker 29 is not installed is configured to be less than the height of the module outlet 27 of the battery modules MD, thereby ensuring smooth flow of gas.

In other words, in the embodiment in FIGS. 10 and 11, since the heat blocker 29 is installed only above the transverse members 33, the height of the longitudinal members 31 is configured to be equal to or less than the height of the module outlets 27 of the first battery modules MD1. In the embodiment in FIGS. 12 and 13, since the heat blocker 29 is installed only above the longitudinal members 31, the height of the transverse members 33 is configured to be equal to or less than the height of the module outlets 27 of the second battery modules MD2.

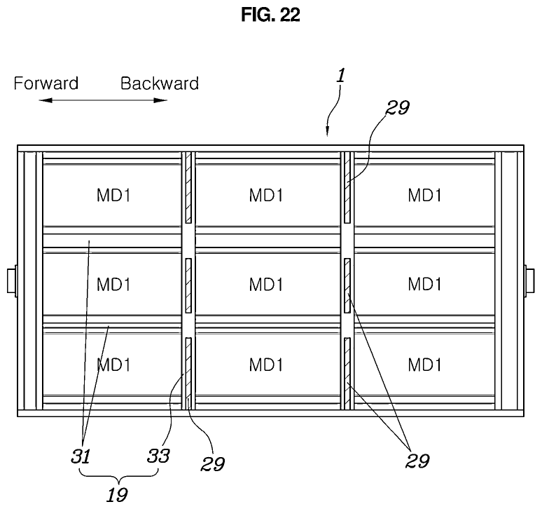

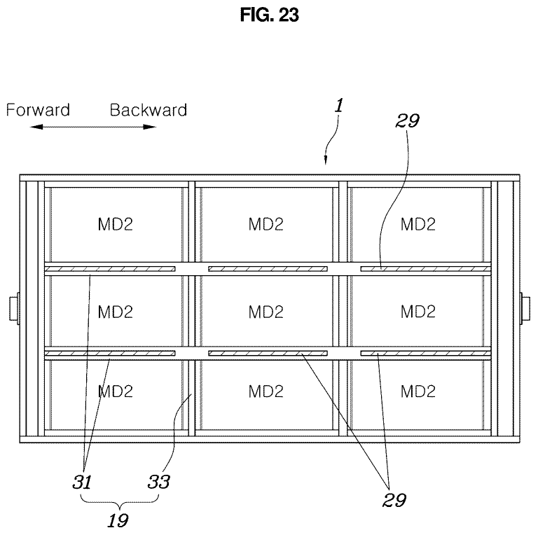

Although the heat blocker 29 is installed along the entire length of the transverse members 33 in the embodiment in FIGS. 10 and 11 and although the heat blocker 29 is installed along the entire length of the longitudinal members 31 in the embodiment in FIGS. 12 and 13, the heat blocker 29 may be installed so as to be divided as shown in FIGS. 22 and 23.

In other words, the heat blocker 29 may be installed to be divided into corresponding portions between adjacent module outlets 27.

In the case of FIG. 22, the heat blocker 29 installed above the transverse members 33 is configured to be divided in corresponding portions between the module outlets 27 of the adjacent first battery modules MD1.

In the case of FIG. 23, the heat blocker 29 installed above the longitudinal members 31 is configured to be divided in corresponding portions between the module outlets 27 of the adjacent second battery modules MD2.

If the divided heat blocker 29 is installed as described above, gas may flow through the divided portions of the heat blocker 29, thereby enabling more rapid discharge of the gas.

In the case of dividing the heat blocker 29 as described above, it would be desirable that the length of a divided portion of a heat blocker 29 is set to 90% or more of a width of a module outlet 27 of a battery module. As a result, the configuration reduces the flow resistance of the gas discharged from the module outlet 27 while securing the blocking effect of the gas.

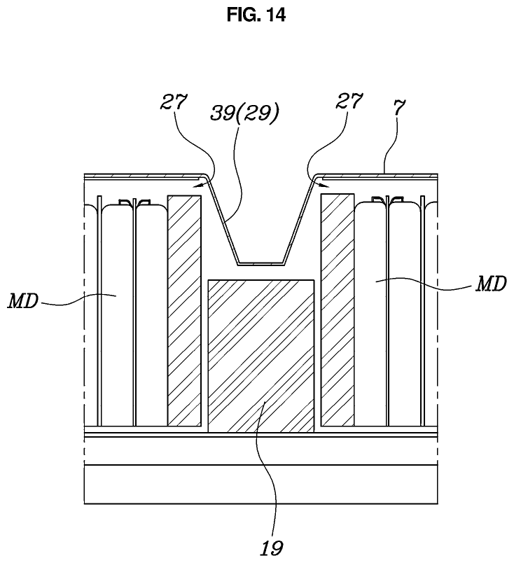

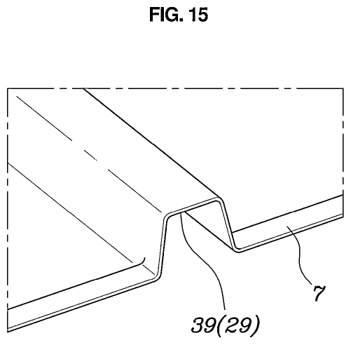

FIGS. 14 and 15 illustrate, in detail, a heat blocker 29 above an inner member 19 in between two portions of battery modules (MD). As shown in detail in FIGS. 14 and 15, the heat blocker 29 may be configured as a channel portion 39 of the pack cover 7, which is formed by bending a portion of the pack cover 7 downwards toward the inner member 19.

In other words, a channel portion 39 is formed to protrude downwards from the pack cover 7 by bending a portion of the pack cover 7 above the inner member 19 downwards as shown in the drawings, so that the channel portion 39 thermally isolates, together with the inner member 19, between the battery modules MD that are disposed on both sides of the inner member 19.

Thermal isolation between the battery modules MD indicates, when heat and gas are emitted because a fire occurs in the one or more battery cells 23 constituting the battery module MD on one side, blocking heat transfer to adjacent battery modules MD by convection, conduction, or radiation.

In the case where the channel portion 39 formed integrally with the pack cover 7 serves as the heat blocker 29 as in this embodiment, if the channel portion 39 protrudes very close to the upper surface of the inner member 19, it is possible to block all transfer of heat by convection, conduction, and radiation.

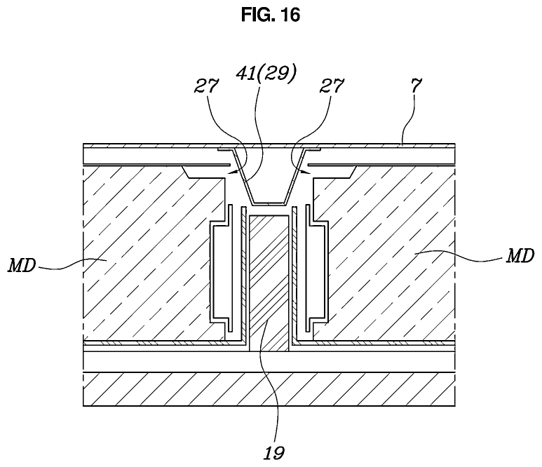

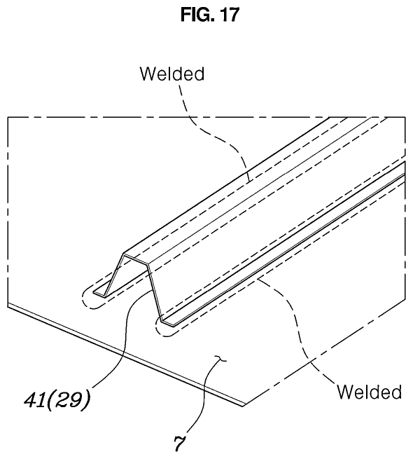

FIGS. 16 and 17 illustrate, in detail, another embodiment where a heat blocker 29 is positioned above an inner member 19 in between two portions of battery modules (MD). Referring to FIGS. 16 and 17, the heat blocker 29 is configured as a blocking bracket 41 that includes a plurality of partition walls protruding from the pack cover 7 toward the inner member 19 and formed extending along the longitudinal direction of the inner member 19. The plurality of partition walls of the blocking bracket 41 is coupled to the lower surface of the pack cover 7.

The blocking bracket 41 is formed to have a cross-section in a trapezoidal shape, and both ends of the trapezoidal cross-section are coupled to the lower surface of the pack cover 7 by welding or the like.

In this case, the blocking bracket 41, like the channel portion 39, may block all transfer of heat by convection, conduction, and radiation between adjacent battery modules MD and may be applied even when it is difficult to process the channel portion 39 on the pack cover 7. Additionally, the blocking bracket 41 is more advantageous in securing the rigidity of the battery pack 1.

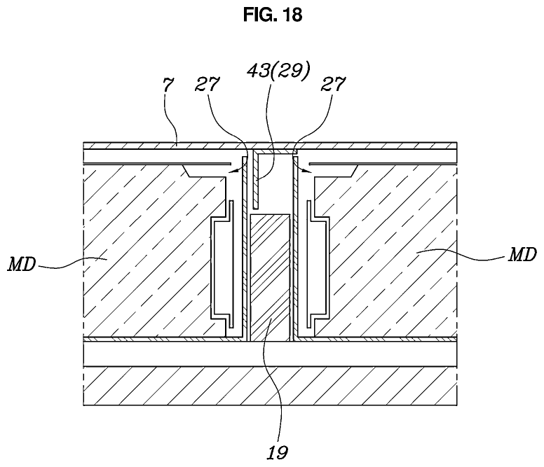

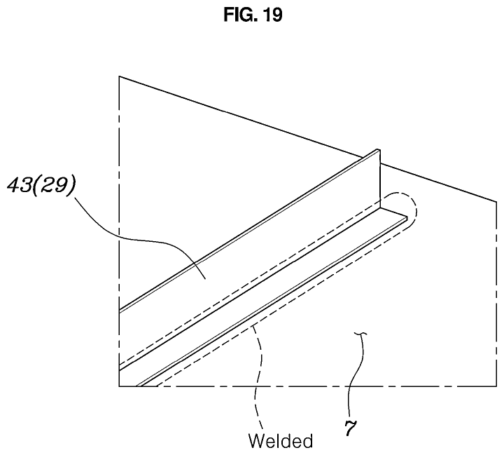

FIGS. 18 and 19 illustrate, in detail, yet another embodiment where a heat blocker 29 is positioned above an inner member 19 in between two portions of battery modules (MD). Referring to FIGS. 18 and 19, the heat blocker 29 is configured as a blocking panel 43 that includes a single partition wall protruding from the pack cover 7 toward the inner member 19 and formed extending along the longitudinal direction of the inner member 19 and is coupled to the lower surface of the pack cover 7.

In this case, the upper end of the blocking panel 43 may be coupled to the lower surface of the pack cover 7 by welding or the like.

The blocking panel 43 may block all transfer of heat between adjacent battery modules MD by convection, conduction, and radiation. Additionally, the blocking panel 43 may also be applied to the case where it is difficult to process the channel portion 39 on the pack cover 7.

In addition, the blocking panel 43 has an advantage of being used to avoid interference with other components in the case where there is not enough space between two adjacent battery modules MD or where other components are located above the inner members 19.

In another embodiment, the heat blocker 29 may be configured as a flame arrestor element 45 installed between the pack cover 7 and the inner member 19.

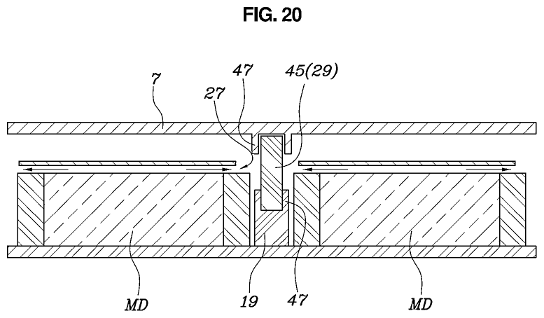

FIG. 20 illustrates an example in which the flame arrestor element 45 is installed as a heat blocker 29 described above. It would be desirable to provide an element guide 47 to support the flame arrestor element 45 in at least one of the lower portion of the pack cover 7 and the upper portion of the inner member 19.

The flame arrestor element 45 refers to a configuration that is made of wire mesh or porous sintered metal that allows the flow of gas while extinguishing a flame by rapidly taking heat through a large surface area when combustion gas passes therethrough.

In this case, the heat blocker 29 configured as the flame arrestor element 45 is also able to effectively block heat transfer between the battery modules MD due to convection, conduction, and radiation.

In yet another embodiment, the heat blocker 29 may be configured as a heat-resistant pad 49 installed between the pack cover 7 and the inner member 19.

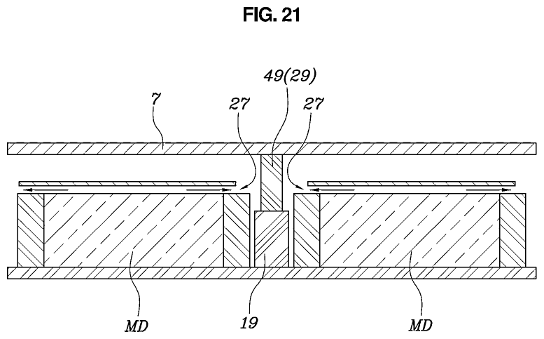

FIG. 21 illustrates that a heat-resistant pad 49 is used as the heat blocker 29.

The heat-resistant pad 49 may be attached to at least one side of the pack cover 7 and the inner member 19 using an adhesive or the like. Additionally, it would be desirable that the heat-resistant pad 49 is compressed between the pack cover 7 and the inner member 19 when the pack cover 7 is coupled to the lower case 3 to some extent, thereby securely fixing the position thereof.

As mentioned above, each battery module MD is provided with a module cover CV that covers the upper sides of the overlapping battery cells 23 and forms a module outlet 27 that is open toward a heat blocker 29.

In other words, referring to FIGS. 10 and 11, a first battery module MD1, which is a type of battery module MD, has a module outlet 27 in the forward and backward directions, and the heat blocker 29 is provided above the transverse member 33, so the module outlet 27 of the first battery module MD1 is open toward the heat blocker 29 above the transverse member 33.

Therefore, if gas and heat are discharged through the module outlet 27 due to a fire occurring in one of the first battery modules MD1, the gas and heat are blocked by the heat blocker 29 above the transverse member 33, thereby preventing the fire from spreading to other adjacent first battery modules MD1.

In other words, in the case of the battery pack 1 in which the first battery module MD1 is accommodated as shown in FIG. 10, if gas is generated from the respective first battery modules MD1, the gas flows along the path indicated by the arrow to be discharged to the outside of the battery pack 1 through the venting mechanism 37.

In addition, referring to FIGS. 12 and 13, a second battery module MD2, which is another type of battery module MD, has a module outlet 27 in the transverse direction, and the heat blocker 29 is provided above the longitudinal member 31, so the module outlet 27 of the second battery module MD2 is open toward the heat blocker 29 above the longitudinal member 31.

Therefore, if gas and heat are discharged through the module outlet 27 due to a fire occurring in one of the second battery modules MD2, the gas and heat are blocked by the heat blocker 29 above the longitudinal member 31, thereby preventing the fire from spreading to other adjacent second battery modules MD2.

In other words, in the case of the battery pack 1 in which the second battery module MD2 is accommodated as shown in FIG. 12, if gas is generated from the respective second battery modules MD2, the gas flows along the path indicated by the arrow to be discharged to the outside of the battery pack 1 through the venting mechanism 37.

The present disclosure described above may also be expressed as follows.

In other words, a battery pack 1 for a vehicle of the present disclosure is configured to include: a front wall 13, a rear wall 15, and both side walls 17 forming an accommodation space S for accommodating a plurality of battery modules MD. The battery pack 1 is further configured to include: a longitudinal member 31 provided extending between the front wall 13 and the rear wall 15 so as to partition the accommodation space S; and a transverse member 33 provided extending between the both side walls 17 so as to partition the accommodation space S. The battery pack 1 is also configured to include a pack cover 7 coupled to the upper portions of the front wall 13, rear wall 15, and both side walls 17 so as to cover the upper portion of the accommodation space S. The battery pack 1 is also configured to include the plurality of battery modules MD disposed in the accommodation space S partitioned by the longitudinal member 31 and the transverse member 33.

In addition, the battery module MD is configured to include a module cover CV that covers the upper portion of the overlapping battery cells 23 and has a module outlet 27 formed to lead to the accommodation space S. The pack cover 7 is configured to include a pack protrusion that protrudes down toward the accommodation space S.

The pack protrusion is a configuration corresponding to the heat blocker 29.

The module outlet 27 formed by the module cover CV of the battery module MD is arranged to face the pack protrusion of the pack cover 7.

The pack protrusion of the pack cover 7 may be formed in at least one of a shape extending toward the front wall 13 and rear wall 15 and a shape extending toward both side walls 17.

The pack protrusion of the pack cover 7 is formed to extend above the longitudinal member 31 along the lengthwise direction of the longitudinal member 31 or is formed to extend above the transverse member 33 along the lengthwise direction of the transverse member 33 such that the gas movement on both sides of the pack protrusion is restricted to each other.

The battery module MD is configured to include: a plurality of battery cells 23 overlapping each other between the two end plates 21 on both sides; and sensing blocks 25 provided on the front and rear sides of the two end plates 21 to make an electrical connection between the battery cells 23 and sense voltage. The battery module is also configured to include a module cover CV coupled to the end plates 21 or sensing blocks 25 to cover the upper portions of the overlapping battery cells 23, thereby restricting heat transfer to the outside of the battery module MD. Additionally, the battery module is configured to include a fireproof panel 51 provided between the battery cells 23 and extending toward the lower surface of the module cover CV to delay heat transfer between the battery cells 23.

For reference, FIG. 3 also illustrates a front module cover 53 and a rear modular cover 55 provided on the outer sides of the sensing blocks 25. FIG. 3 also illustrates a lower bracket 57 provided below the battery cells 23 and the end plates 21 to connect and fix two end plates 21.

In the first battery module MD1 shown in FIGS. 4 to 6, the fireproof panel 51 is configured to form a plane perpendicular to the module outlet 27 of the module cover CV and to be located between the battery cells 23.

Accordingly, if gas is generated due to a fire in any battery cell 23, the gas may be easily discharged to the module outlet 27 along the passage formed between the fireproof panel 51, the module cover CV, and the battery cell 23, thereby effectively preventing the spread of fire to adjacent battery cells 23.

In the second battery module MD2, shown in FIGS. 7 to 9, the fireproof panel 51 is configured to have a connection groove 59 formed on the upper portion thereof to be locally spaced apart from the lower surface of the module cover CV.

Therefore, if gas is generated in any portion of the battery cell 23, the gas may flow through the connection groove 59 to then be discharged through the module outlet 27, thereby effectively delaying the spread of fire to other portions of the battery cell 23.

It may also be desirable that the connection grooves 59 of all fireproof panels 51 provided in the second battery module MD2 communicate with each other along the transverse direction of the second battery module MD2 in order to easily discharge the gas through the connection groove 59 as described above.

For reference, it is preferable to understand that arrows without other marks in the drawing illustrate the flow of gas discharged when a fire occurs in the battery cell 23.

Although the present disclosure has been described and illustrated in conjunction with particular embodiments thereof, it should be apparent to those having ordinary skill in the art that various improvements and modifications may be made to the present disclosure without departing from the technical idea of the present disclosure defined by the appended claims.

What is claimed is:

1. A battery pack for a vehicle, the battery pack comprising:
a plurality of battery modules arranged on a plane;
a lower case forming an accommodation space surrounding lower and lateral portions of the plurality of battery modules;
a pack cover coupled to an upper portion of the lower case so as to cover the upper portion of the accommodation space;
a plurality of inner members provided in the accommodation space to separate the plurality of battery modules; and
a heat blocker provided between the pack cover and the plurality of inner members and configured to thermally isolate the plurality of battery modules separated by the plurality of inner members.

2. The battery pack of claim 1, wherein the lower case comprises a front wall, a rear wall, and a pair of side walls connecting both ends of the front wall and rear wall in a forward and backward direction of the lower case, and
wherein the plurality of inner members comprises a longitudinal member installed to extend in the forward and backward direction of the lower case and a transverse member installed to extend in a transverse direction of the lower case to intersect with the longitudinal member.

3. The battery pack of claim 2, wherein at least one of the front wall, the rear wall, and the pair of side walls of the lower case has a venting mechanism configured to discharge gas generated from the plurality of battery modules to an outside.

4. The battery pack of claim 1, wherein the heat blocker is configured to extend along a lengthwise direction of an inner member of the plurality of inner members and above the inner member.

5. The battery pack of claim 4, wherein the heat blocker is configured as a channel portion of the pack cover, which is formed by bending a portion of the pack cover down toward the inner member.

6. The battery pack of claim 4, wherein the heat blocker is configured as a blocking bracket that comprises a plurality of partition walls protruding from the pack cover toward the inner member and formed to extend along the lengthwise direction of the inner member and is coupled to a lower surface of the pack cover.

7. The battery pack of claim 6, wherein the blocking bracket is formed to have a cross-section in a trapezoidal shape, and ends of the trapezoidal cross-section are coupled to the lower surface of the pack cover.

8. The battery pack of claim 4, wherein the heat blocker is configured as a blocking panel comprising a single partition wall protruding from the pack cover toward the inner member, and
wherein the blocking panel is formed to extend along the lengthwise direction of the inner member and coupled to a lower surface of the pack cover.

9. The battery pack of claim 4, wherein the heat blocker is configured as a flame arrestor element installed between the pack cover and the inner member, and
wherein an element guide supporting the flame arrestor element is provided in at least one of a lower portion of the pack cover and an upper portion of the inner member.

10. The battery pack of claim 4, wherein a height of the inner member above which the heat blocker is not provided, among the plurality of inner members, is equal to or less than a height of a module outlet of a battery module of the plurality of battery modules.

11. The battery pack of claim 4, wherein the heat blocker is configured as a heat-resistant pad installed between the pack cover and the inner member, and
wherein the heat-resistant pad is attached to at least one side of the pack cover and the inner member.

12. The battery pack of claim 4, wherein a module outlet of a battery module of the plurality of battery modules is disposed toward the heat blocker, and
wherein the heat blocker is divided in corresponding portions between adjacent module outlets.

13. The battery pack of claim 2, wherein a battery module of the plurality of battery modules comprises a module cover that covers upper sides of overlapping battery cells and forms a module outlet that is open toward the heat blocker.

14. A battery pack for a vehicle, the battery pack comprising:
a front wall, a rear wall, and a pair of side walls forming an accommodation space for accommodating a plurality of battery modules;
a longitudinal member configured to extend between the front wall and the rear wall so as to partition the accommodation space;
a transverse member configured to extend between the pair of side walls so as to partition the accommodation space;
a pack cover coupled to upper portions of the front wall, the rear wall, and the pair of side walls so as to cover the accommodation space; and
a plurality of battery modules disposed in the accommodation space partitioned by the longitudinal member and the transverse member,
wherein a battery module of the plurality of battery modules comprises a module cover configured to cover upper portions of overlapping battery cells and have a module outlet leading to the accommodation space, and
wherein the pack cover has a pack protrusion that protrudes down toward the accommodation space.

15. The battery pack of claim 14, wherein the module outlet formed on the module cover of the battery module is disposed to face the pack protrusion of the pack cover.

16. The battery pack of claim 14, wherein the pack protrusion of the pack cover is formed in at least one of a shape extending toward the front wall and rear wall and a shape extending toward the pair of side walls.

17. The battery pack of claim 14, wherein the pack protrusion of the pack cover extends above the longitudinal member or transverse member along a lengthwise direction of the longitudinal member or transverse member so that gas movement on both sides of the pack protrusion is restricted to each other.

18. The battery pack of claim 14, wherein the battery module comprises:
a plurality of battery cells overlapping each other between two end plates on both sides;
sensing blocks provided on front and rear sides of the two end plates and configured to make an electrical connection between the battery cells and sense voltage;
a module cover coupled to the two end plates or sensing blocks to cover the upper portions of the overlapping battery cells, such as to restrict heat transfer to an outside of the battery module; and
a fireproof panel provided between the battery cells and extending toward a lower surface of the module cover to delay heat transfer between the battery cells.

19. The battery pack of claim 18, wherein the fireproof panel is configured to form a plane perpendicular to the module outlet of the module cover and to be provided between the battery cells.

20. The battery pack of claim 18, wherein the fireproof panel has a connection groove formed on the upper portion thereof to be locally spaced apart from the lower surface of the module cover.
